(19) United States
(12) Patent Application Publication
(10) Pub. No.: US 2008/0156579 A1
(43) Pub. Date: Jul. 3, 2008

(54) Air intake device

(75) Inventor: Kazuhiro Hayashi, Nishikamo-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/902,408

(22) Filed: Sep. 21, 2007

(30) Foreign Application Priority Data
Sep. 29, 2006 (JP) 2006-266692

(51) Int. Cl. F02M 35/12; F02M 35/104

(52) U.S. Cl. 181/229; 123/184.21

(57) ABSTRACT

An air intake device includes an inner pipe member having a substantially cylindrical shape and defining therein an air intake passage by a wall portion of the inner pipe member, and an outer pipe member which surrounds a periphery side of the inner pipe member to define therebetween a space. The air intake passage communicates a surge tank with an atmosphere intake port through which air is introduced into the surge tank. The wall portion of the inner pipe member has at least one sound transmission portion through which sound is more readily transferred than other portions of the wall portion. The space has one end which is opening and positioned at a side of the atmosphere intake port, and the other end which is closed and positioned at a side of the surge tank.

### CROSS REFERENCE TO RELATED APPLICATION

This application is based on a Japanese Patent Application No. 2006-266692 filed on Sep. 29, 2006, the disclosure of which is incorporated herein by reference.

### FIELD OF THE INVENTION

The present invention relates to an air intake device.

### BACKGROUND OF THE INVENTION

Generally, it is desirable to reduce air intake noise (air intake sound) in an air intake passage in which intake air which is sucked to an internal-combustion engine flows. For example, with reference to JP-56-138108A, a side branch is arranged at the periphery side of a pipe member which forms the air intake passage, so that a resonance frequency varies corresponding to the length of the axial direction of the side branch. Thus, the noise having the natural frequency of the intake air flowing in the air intake passage is reduced.

However, the efficiency for filling the intake air (sucked to internal-combustion engine) into the internal-combustion engine will become high with the temperature of the intake air becoming lower. Thus, it is desirable to cool air sucked to the internal-combustion engine to improve the output of the internal-combustion engine.

According to JP-10-274044A, a cooling passage is arranged to be adjacent to an air intake passage where intake air sucked to the internal-combustion engine flows, to improve the cooling of the intake air sucked to the internal-combustion engine and enhance the output of the internal-combustion engine. Moreover, with the temperature of the intake air becoming low, knocking can be restricted and ignition timing can be moved ahead to an optimum timing to improve the output.

However, in JP-56-138108A, the two axial-direction ends of the side branch are closed. Therefore, air cannot flow between the side branch and the pipe member. In this case, it is difficult to substantially cool air flowing in the air intake passage. Moreover, the sound of the resonance frequency of the side branch which is determined by the whole length of the side branch is reduced. Thus, it is difficult to reduce the sound of a frequency other than the determined frequency.

On the other hand, according to JP-10-274044A, although the cooling of the intake air is improved, it is difficult to reduce the sound (noise) of the intake air.

### SUMMARY OF THE INVENTION

In view of the above-described disadvantage, it is an object of the present invention to provide an air intake device where a reduction of air intake noise of a broad frequency band and a cooling of intake air are compatible.

According to the present invention, an air intake device includes an inner pipe member having a substantially cylindrical shape and defining therein an air intake passage by a wall portion of the inner pipe member, and an outer pipe member which surrounds a periphery side of the inner pipe member to define therebetween a space. The air intake passage communicates a surge tank with an atmosphere intake port through which air is introduced into the surge tank. The wall portion of the inner pipe member has at least one sound transmission portion through which sound is more readily transferred than other portions of the wall portion. The space has one end which is opening and positioned at a side of the atmosphere intake port, and the other end which is closed and positioned at a side of the surge tank.

Thus, the intake air flowing in the air intake passage formed by the inner pipe member is cooled by the air introduced in to the space. Moreover, the inner pipe member has the sound transmission portion which is formed at the wall portion defining the air intake passage. The sound of the intake air flowing in the air intake passage is emitted to the space from the sound transmission portion. A part of the sound emitted from the sound transmission portion is transferred to the opening end of the atmosphere intake side from the sound transmission portion, and other part of the sound is transferred to the side of the sound transmission portion after being transferred to the side (which is closed) of the surge tank from the sound transmission portion. By setting the distance between the sound transmission portion of the space and the atmosphere intake side and the distance between the sound transmission portion and the surge tank side, the sound having different frequency is attenuated by the transference path. Therefore, the air intake sound having a broad frequency band can be reduced, while the temperature of the intake air flowing in the air intake passage can be lowered.

### BRIEF DESCRIPTION OF THE DRAWINGS

Other objects, features and advantages of the present invention will become more apparent from the following detailed description made with reference to the accompanying drawings, in which:

FIG. 1 is a schematic sectional view showing an air suction system where an air intake device is suitably used according to an exampled embodiment of the present disclosure;

FIG. 2A is a schematic sectional view taken along the line IIA-IIA in FIG. 1, FIG. 2B is a schematic sectional view taken along the line IIB-IIB in FIG. 1, FIG. 2C is a schematic sectional view taken along the line IIC-IIC in FIG. 1, and FIG. 2D is a schematic sectional view taken along the line IID-IID in FIG. 1;

FIG. 3 is a partially sectional view showing the air intake device according to the exampled embodiment;

FIG. 4 is a schematic sectional view showing a sound transference path according to the exampled embodiment; and

FIG. 5 is a graph showing relations between a frequency and a sound pressure level respectively in the air intake device according to the exampled embodiment of the present disclosure and an air intake device according to a comparison example.

### DETAILED DESCRIPTION OF THE EXAMPLED EMBODIMENTS

### Exampled Embodiment

An air intake device 20 according to an exampled embodiment of the present invention will be described with reference to FIGS. 1-5. FIG. 1 shows an air intake system 10 where the air intake device 20 is suitably used.

As shown in FIG. 1, the air intake system 10 includes the air intake device 20, an air cleaner 11 and an engine 12 (for example, internal-combustion engine). The air intake device 20 has a surge tank 21 which are communicated with multiple intake manifolds 22. That is, the intake manifolds 22 are branched from the surge tank 21, and have the number corresponding to the number of the cylinders 13 of the engine 12 to be respectively connected with the cylinders 13.

The air cleaner 11 is mounted to an end of the air intake device 20, and houses therein an air cleaner element (not shown). This end is positioned at an opposite side of the air intake device 20 to the engine 12. Air sucked into the engine 12 passes through the air cleaner 11, so that foreign matter can be eliminated.

The air intake device 20 has an intake pipe 23 where a throttle 24 is arranged to open and close an intake passage 25 defined by the intake pipe 23. Thus, the flow amount of intake air flowing in the intake passage 25 can be adjusted by the throttle 24.

The air intake device 20 is provided with an inner pipe member 31 and an outer pipe member 32. The inner pipe member 31 has a substantially cylindrical shape or the like, and has one axial-direction end which is opening to atmosphere of the side of the air cleaner 11. The other axial-direction end of the inner pipe member 31 is connected with the surge tank 21 through the intake pipe 23.

The intake passage 25 is defined by the wall portion of the inner pipe member 31 and the wall portion of the intake pipe 23. One end of the intake passage 25 constructs an atmosphere intake port 33 (intake port) through which air is introduced into the intake passage 25, and the other end of the intake passage 25 is connected with the surge tank 21 through the throttle 24. Air having passed through the air cleaner 11 flows into the surge tank 21 through the intake passage 25, to be supplied for the multiple cylinders 13 of the engine 12 through the intake manifolds 22.

The outer pipe member 32 and the inner pipe member 31 can be substantially coaxially arranged. That is, the outer pipe member 32 and the inner pipe member 31 have the substantially same axis. The outer pipe member 32 is arranged at the diameter-direction outer side of the inner pipe member 31. That is, the outer pipe member 32 surrounds the inner pipe member 31. The inner pipe member 31 is axially partially housed in the outer pipe member 32. That is, the outer pipe member 32 covers a part of the inner pipe member 31 with respect to the axis direction, at the outer side of the inner pipe member 31.

The outer pipe member 32 has a substantially cylindrical shape, and is bottomed at the one end thereof of the side of the surge tank 21. That is, a bottom portion 34 having a ring shape is arranged between the outer pipe member 32 and the outer surface of the inner pipe member 31. Thus, the one end of the outer pipe member 32 of the side of the surge tank 21 contacts the inner pipe member 31. In contrast, the other end (of the side of intake port 33) of the outer pipe member 32 is opening to the atmosphere. Alternatively, the inner pipe member 31 and the outer pipe member 32 can be also arranged at an off-center state. That is, the axis of the inner pipe member 31 can be set different from that of the outer pipe member 32.

A space 35 is formed between the inner pipe member 31 and the space 35. In this case, the outer pipe member 32 is provided with the bottom portion 34 at the side of the surge tank 21, so that the one end (of the side of surge tank 21) of the space 35 is closed. The other end (of the side of the intake port 33) of the space 35 is opening to the atmosphere. That is, the space 35 has the closed end at the side of the surge tank 21, and the opening end at the side of the intake port 33. Alternatively, the end of the space 35 of the side of the intake port 33 can be also connected with the air cleaner 11.

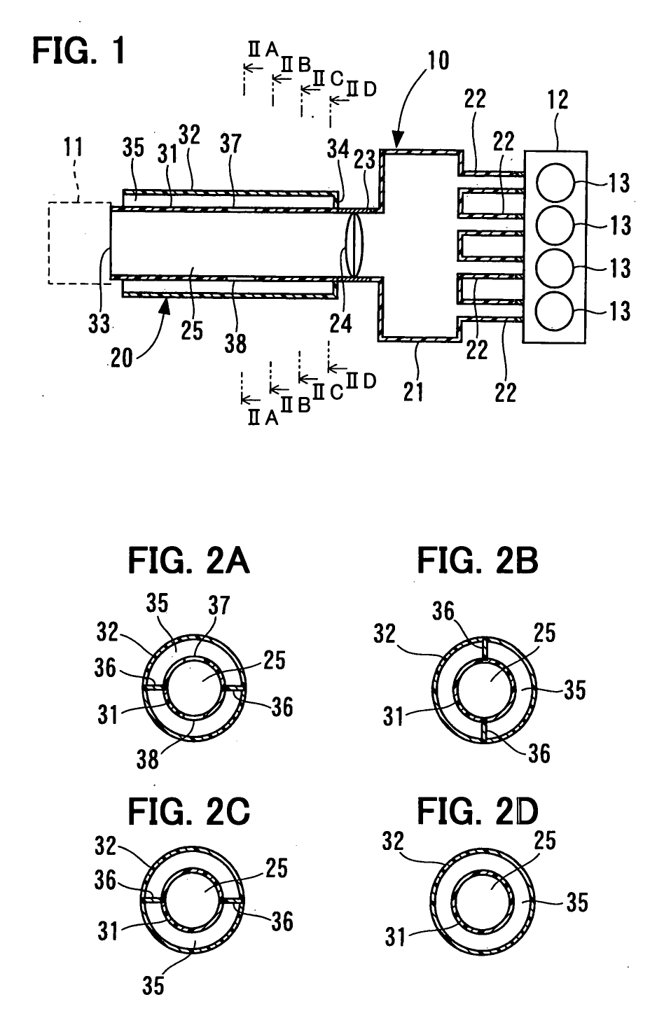

As shown in FIG. 2, a partition wall 36 is arranged between the inner pipe member 31 and the outer pipe member 32. In FIGS. 1 and 4, the indication of the partition wall 36 is omitted. The partition wall 36 contacts an outer surface of the inner pipe member 31 and an inner surface of the outer pipe member. The partition wall 36 partitions the space 35 formed between the inner pipe member 31 and the outer pipe member 32 into at least two spaces, and supports the outer pipe member 32 at the inner pipe member 31. That is, the inner pipe member 31 and the outer pipe member 32 are integrated with each other via the partition wall 36.

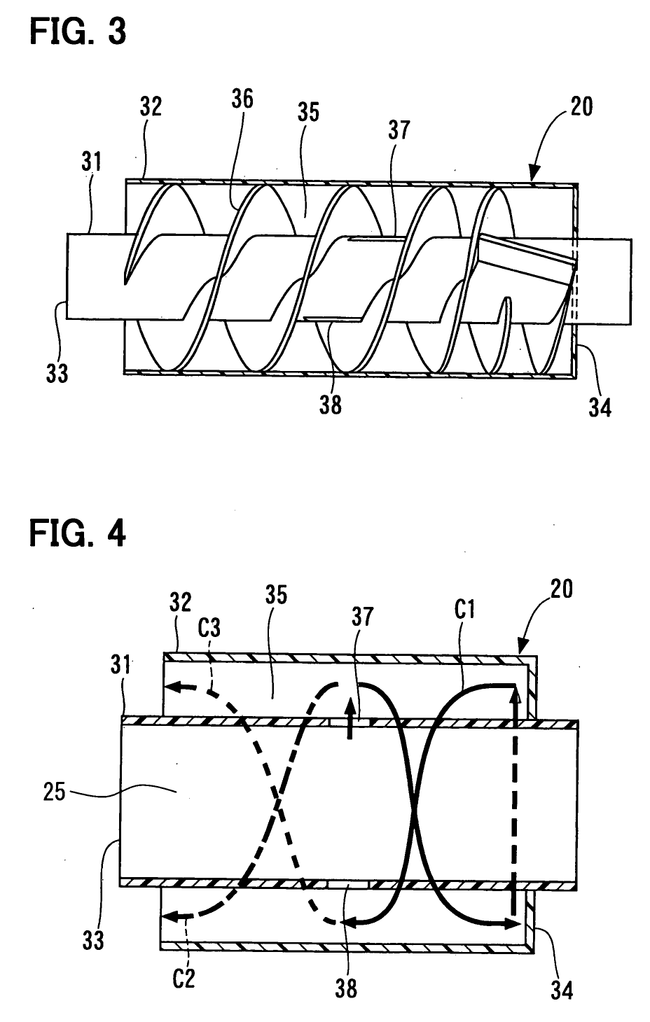

With reference to FIG. 3, the partition wall 36 can be provided with a helical shape with respect to the axis direction of the inner pipe member 31 and the outer pipe member 32. Thus, the space 35 formed between the inner pipe member 31 and the outer pipe member 32 is partitioned by the partition wall 36 having the helical shape.

As shown in FIGS. 1 and 3, sound transmission portions 37 and 38 are formed at the wall portion (which defines the intake passage 25) of the inner pipe member 31, to be a part through which sound is more readily transferred than other portions of the wall portion. The sound transmission portions 37 and 38 can be constructed in such a manner that sound is capable of coming and going between the intake passage 25 (formed in inner pipe member 31) and the space 35 formed at the outer side of the inner pipe member 31.

For example, the sound transmission portion 37, 38 can be constructed of an opening portion such as a slit or a window to penetrate the inner pipe member 31 in the thickness direction of the inner pipe member 31 which defines therein the intake passage 25.

Alternatively, the sound transmission portion 37, 38 can be also constructed of an opening portion which is formed at the inner pipe member 31 and covered by a porous member such as a sponge or a film member (for example, rubber film and paper film). In the case where the sound transmission portion 37, 38 is provided with thereat the porous member, the sound passing through the sound transmission portion 37, 38 is attenuated over a broad frequency field.

More alternatively, the sound transmission portion 37, 38 can be also constructed of a thin-walled portion which is formed at the inner pipe member 31 and has a smaller thickness than the other part of the inner pipe member 31.

By providing the porous member, the film member or the thin-walled portion for the sound transmission portion 37, 38, a barrier is formed between the space 35 and the intake passage 25. Therefore, even in the case where the air cleaner 11 is arranged at the end of the space 35 of the side of the intake port 33, the intrusion of the foreign matter upon the intake passage 25 from the space 35 can be restricted.

The sound transmission portion 37, 38 is arranged at a halfway portion of the axial direction of the inner pipe member 31. The sound transmission portion 37 and the sound transmission portion 38 are respectively arranged at the two diameter-direction ends of the inner pipe member 31, as shown in FIGS. 1, 2A, and FIG. 3.

In this embodiment, the sound transmission portion 37 and the sound transmission portion 38 face each other. Thus, the sound transmission portion 37 and the sound transmission portion 38 are respectively arranged at the two parts of the space 35 which are partitioned from each other by the partition wall 36.

Next, the mechanism for reducing the air intake noise in the air intake system 10 will be described.

The sound of intake air (that is, air intake noise) flowing in the intake passage 25 defined in the inner pipe member 31 is emitted to the space 35 through the sound transmission portion 37 as shown in FIG. 4. The sound having been emitted to the space 35 is partially transferred to the side of the surge tank 21. The sound having been transferred to the side of the surge tank 21 is reflected at the bottom portion 34 which is the end portion of the outer pipe member 32 of the side of the surge tank 21.

The sound having been reflected at the bottom portion 34 is transferred toward the sound transmission portion 38, and this sound is partially emitted to the side of the intake passage 25 from the sound transmission portion 38. In this case, the transference path of the sound from the sound transmission portion 37 to the sound transmission portion 38 through the bottom portion 34 is defined as a first path C1.

The sound having been emitted to the space 35 from the sound transmission portion 37 is partially transferred directly to the opening end of the space 35 of the side of the intake port 33, without through the first path C1. Thus, a transference path of the sound from the sound transmission portion 37 directly to the opening end of the space 35 of the side of the intake port 33 is defined as a second path C2. Similarly, a transference path of the sound from the sound transmission portion 38 directly to the opening end of the space 35 of the side of the intake port 33 is defined as a third path C3.

Furthermore, the sound having been transferred from the sound transmission portion 37 through the first path C1 to the sound transmission portion 38 is partially transferred to the opening end of the side of the intake port 33 through the second path C2 or the third path C3 (without passing through sound transmission portion 38), to be emitted to the exterior.

Thus, the sound having been emitted from the intake passage 25 through the sound transmission portion 37 and the sound transmission portion 38 to the space 35 is transferred through the first path C1, the second path C2, and the third path C3. The first path C1, the second path C2, and the third path C3 for transferring the sound are respectively provided with whole lengths which are different from each other. Therefore, at the each of the first path C1, the second path C2, and the third path C3, the sound having the natural frequency of the path is attenuated.

Moreover, by suitably setting the whole lengths of the first path C1, the second path C2, and the third path C3, the sound having been emitted to the space 35 from the sound transmission portion 37 can be provided with a phase which is reverse to the sound having been emitted from the sound transmission portion 38 to the space 35. Because the phases of the sounds emitted to the space 35 are reverse, the sound emitted from the sound transmission portion 37 to the exterior and that emitted from the sound transmission portion 38 to the exterior can be counteracted with each other. Therefore, the sound emitted from the intake passage 25 to the exterior can be reduced.

Because the partition wall 36 is provided with the helical shape, the whole lengths of the first path C1, the second path C2, and the third path C3 are enlarged so that the wavelength of the sound attenuated at the space 35 becomes long and the frequency of the sound becomes low. Thus, the sound (among sound generated due to intake air flowing in the intake passage 25) which has a frequency in a low frequency field to be difficultly eliminated can be efficiently restricted, by enlarging the whole lengths of the first path C1, the second path C2, and the third path C3.

As described above, the frequencies of the sound attenuated at the first path C1, the second path C2, and the third path C3 are different from each other in response to the whole lengths of the first path C1, the second path C2, and the third path C3. In this case, when the whole length of the first path C1 is set as L1, the sound having a frequency which is an odd multiple of the natural frequency f1 of the first path C1 is attenuated at the first path C1. In this case, the frequency f1 is calculated according to the formula of f1=(c/2/L1) wherein c represents a sound speed.

As shown in FIG. 4, the whole lengths of the second path C2 and the third path C3 can be respectively indicated as L2 and L3. The second path C2 and the third path C3 can be provided with the same whole length, for example. In this case, the sound having a frequency which is an odd multiple of the natural frequency f2 of the second path C2 is attenuated at the second path C2 and the third path C3. In this case, the frequency f2 is calculated according to the formula of f2=(c/2/L2) wherein c represents the sound speed.

By setting L1=2×L2, the sound having a frequency which is an even multiple of the frequency f2 (of the sound attenuated at second path C2) is attenuated at the first path C1. The sound having the frequency which is the odd multiple of the frequency f2 is attenuated at the second path C2 and the third path C3.

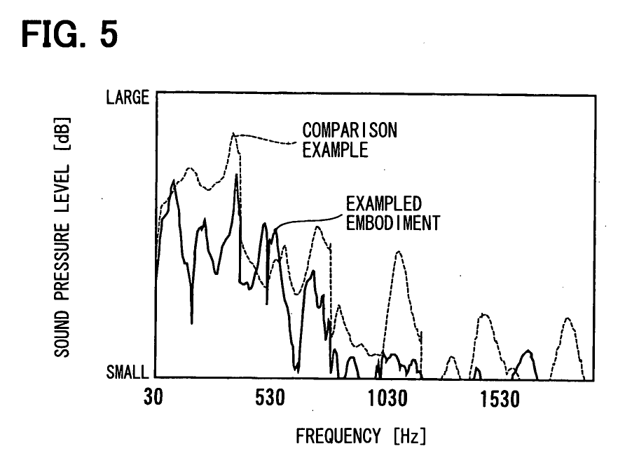

Therefore, according to this embodiment, as shown in FIG. 5, the sound in a broad frequency field can be reduced. The evaluation shown in FIG. 5 is performed by arranging a speaker or the like at one side of the axial direction of the inner pipe member 31 and arranging a microphone or the like at the other side of the axial direction of the inner pipe member 31 to detect the sound. In FIG. 5, the air intake device 20 having the partition wall 36 with the helical shape (as shown in FIG. 3) according to this embodiment is compared with an air intake device (without being provided with partition wall 36) having a double-cylinder shape as a comparison example.

Next, the mechanism for cooling the intake air in the air intake system 10 will be described.

As shown in FIGS. 1, 3 and 4, the space 35 formed between the inner pipe member 31 and the outer pipe member 32 is provided with the opening end at the side opposite to the surge tank 21. Therefore, air is introduced into the space 35 from the side of the opening end. By respectively arranging the intake port 33 (defined by inner pipe member 31) and the opening end of the space 35 at the different positions, that is, by introducing air into the space 35 from the part having the position different from that the intake port 33, air having a temperature different from the intake passage 25 is introduced into the space 35.

Thus, by introducing air having a lower temperature than the intake air flowing in the intake passage 25 into the space 35, the inner pipe member 31 can be cooled by air in the space 35 and cooled by the intake air flowing in the intake passage 25.

According to this embodiment, the multiple transference paths for transferring the sound having been emitted from the sound transmission portion 37 and the sound transmission portion 38 of the inner pipe member 31 are formed in the space 35 arranged between the inner pipe member 31 and the outer pipe member 32. Thus, the attenuation property of the sound having been emitted from the sound transmission portion 37 and that of the sound having been emitted from the sound transmission portion 38 are different from each other in response to the different transference paths, so that the sound of the intake air in a broad range can be reduced.

Moreover, the inner pipe member 31 defining therein the intake passage 25 is cooled by air introduced into the space 35 formed between the inner pipe member 31 and the outer pipe member 32. Thus, the temperature of the intake air flowing in the intake passage 25 is lowered, so that the efficiency for filling the intake air to the cylinders 13 of the engine 12 can be improved. Thus, the output of the engine 12 can be increased. Therefore, according to this embodiment, the reduction of the sound of the intake air flowing in the intake passage 25 and the cooling of the intake air can be compatible.

### Other Embodiments

Although the present invention has been fully described in connection with the preferred embodiments thereof with reference to the accompanying drawings, it is to be noted that various changes and modifications will become apparent to those skilled in the art.

According to the above-described exampled embodiment, the air intake system 10 is provided with the partition wall 36, which has the substantially helical shape and is arranged between the inner pipe member 31 and the outer pipe member 32. However, the shape of the partition wall 36 is not limited to the helical shape where the angle (with respect to axial direction of inner pipe member 31) continuously varies in the axial direction thereof. For example, the partition wall 36 can be also constructed of multiple wall portions having the angles which discontinuously vary with respect to the axis direction.

Moreover, in the exampled embodiment, the inner pipe member 31 is provided with the substantially cylindrical shape having a constant diameter with respect to the axis direction. However, the inner pipe member 31 can be also provided with a conic shape which has the diameter varying with respect to the axial direction.

Furthermore, the sound having the high frequency can be reduced, by shortening the sound transference paths C1, C2, and C3, or by providing a construction where the angle of the partition wall 36 does not vary.

Such changes and modifications are to be understood as being in the scope of the present invention as defined by the appended claims.

What is claimed is:

1. An air intake device comprising:
an inner pipe member having a substantially cylindrical shape and defining therein an air intake passage by a wall portion of the inner pipe member, the air intake passage communicating a surge tank with an atmosphere intake port through which air is introduced into the surge tank,
the wall portion of the inner pipe member having at least one sound transmission portion through which sound is more readily transferred than other portions of the wall portion; and
an outer pipe member which surrounds a periphery side of the inner pipe member to define therebetween a space, the space having one end which is opening and positioned at a side of the atmosphere intake port and an other end which is closed and positioned at a side of the surge tank.

2. The air intake device according to claim 1, further comprising
a partition wall which contacts an outer surface of the inner pipe member and an inner surface of the outer pipe member to partition the space into at least two parts.

3. The air intake device according to claim 2, wherein the partition wall has a helical shape in an axial direction of the inner pipe member and the outer pipe member.

4. The air intake device according to claim 2, wherein
each of the parts of the space partitioned by the partition wall is provided with the one sound transmission portion.

5. The air intake device according to claim 4, wherein
the sound transmission portions are respectively arranged at two diameter-direction ends of the inner pipe member.

6. The air intake device according to claim 4, wherein
the space forms at least two sound transference paths from the sound transmission portions.

7. The air intake device according to claim 6, wherein:
a whole length of one of the sound transference paths is set in such a manner that sound having a frequency which is an odd multiple of a natural frequency of the one of the sound transference paths is attenuated at the one of the sound transference paths; and
a whole length of the other of the sound transference paths is set in such a manner that sound having a frequency which is an even multiple of the natural frequency of the one of the sound transference paths is attenuated at the other of the sound transference paths.

8. The air intake device according to claim 6, wherein
whole lengths of the sound transference paths are set in such a manner that phases of sounds emitted from sound transmission portions to the space are reverse to each other.
